(19) United States
(12) Patent Application Publication
(10) Pub. No.: US 2005/0229877 A1
(43) Pub. Date: Oct. 20, 2005

(54) Dual overhead camshaft V-2 engine

(76) Inventors: James Botelho, Danbury, CT (US); Josef Visinski, Shelton, CT (US); Andrew Visinski, Shelton, CT (US); Joseph LaPine, Danbury, CT (US)

Correspondence Address: David L. Principe;Hodgson Russ LLP, Suite 2000, One M&T Plaza, Buffalo, NY, 14203-2391, US

(21) Appl. No.: 10/825,989

(22) Filed: Apr. 16, 2004

(51) Int. Cl. F02B 75/22

(52) U.S. Cl. 123/54.4

(57) ABSTRACT

A V-2 engine; with four valves per cylinder, dual overhead camshafts, offset cylinders, and a single crankpin crankshaft; that will fit onto the stock front and rear EVO crankcase mounts, the stock primary drive and crankshaft mounting locations, and within the frame rails of a stock size EVO chassis (whether OEM or aftermarket).

### FIELD OF THE INVENTION

This invention relates to an improvement in a two-cylinder V-type spark-ignition engine with overhead camshafts, generally called a dual overhead (DOHC) V-2 engine.

### BACKGROUND OF THE INVENTION

Around 1984 the Harley-Davidson Motor Company introduced the 1340 EVOLUTION® motorcycle engine (EVO), and Harley-Davidson continued to produce models that utilized the EVO engine until about 1999. Throughout this time period, there were also many aftermarket manufacturers that produced frames, engines and power transmission components suitable for use with the EVO platform.

As with all engines, the original factory EVO engines have specific frame and power transmission mounting components and locations. Many aftermarket engine manufacturers produce their designs based on this EVO mounting configuration. As a result, these engines will fit as direct replacements for the original equipment manufacturer (OEM) equipment and there are no alterations to the frame or power transmission mounting components required.

Because of the popularity of the EVO engine and the large aftermarket following that it has gained, the engine is arguably the most widely used platform for custom builders and performance enthusiasts.

Accordingly, there is a need for aftermarket engines that will fit onto the stock front and rear EVO crankcase mounts and the stock primary drive and crankshaft mounting locations. These engines also must fit within the frame rails of a stock size EVO chassis, whether OEM or aftermarket.

### SUMMARY OF THE INVENTION

The present invention meets the above described need by providing a V-2 engine; with four valves per cylinder, dual overhead camshafts, offset cylinders, and a single crankpin crankshaft; that will fit onto the stock front and rear EVO crankcase mounts, the stock primary drive and crankshaft mounting locations, and within the frame rails of a stock size EVO chassis (whether OEM or aftermarket).

The above and other features and advantages of the present invention will become manifest to those versed in the art upon making reference to the following description and accompanying sheets of drawings in which preferred structural embodiments incorporating the principles of the invention are shown by way of illustrative examples.

### BRIEF DESCRIPTION OF THE DRAWINGS

FIG. 1 is a side elevational view of a DOHC V-2 engine according to an embodiment of the present invention;

FIG. 2 is a cross-sectional view taken along lines 2-2 of FIG. 1;

FIG. 3 is a rear elevational view of the engine of the present invention;

FIG. 4 is a cross-sectional view taken along lines 4-4 of FIG. 3;

FIG. 5 is a side perspective view of the engine shown from the side opposite of the side shown in FIG. 1, with covers removed for clarity;

FIG. 6 is a side perspective view of the linkage for the engine shown in FIG. 5 with the covers, cylinders and cylinder heads removed for clarity;

FIG. 7 is a view similar to FIG. 6, but shown from the opposite side;

FIG. 8 is a side elevational view showing the cylinder configuration with the heads and cylinders removed for clarity;

FIG. 9 is a top plan view of the components shown in FIG. 8;

FIG. 10 is a side elevational view showing the configuration for mounting the power transmission components to the engine;

FIG. 11 is a bottom plan view showing the configuration for mounting the engine to the frame; and,

FIG. 12 is a perspective view of a frame suitable for use with the present invention.

### DETAILED DESCRIPTION OF THE PREFERRED EMBODIMENT

The following description is merely exemplary in nature and is in no way intended to limit the invention or its application or use.

Referring to FIG. 1, there is shown a dual overhead camshaft (DOHC) V-2 engine according to an embodiment of the present invention. As shown the engine 10 is of the type suitable for mounting in a motorcycle frame such that the engine 10 has front cylinder block 13 disposed on the left hand side of the figure which corresponds to the front of the motorcycle and a rear cylinder block 16 disposed on the right hand side of the figure which corresponds to the rear of the motorcycle. The cylinder blocks 13 and 16 are configured at positions described in greater detail herein. The engine 10 has a crankshaft 19 that extends horizontally (normal to the page in FIG. 1). The engine 10 includes a crankcase 22.

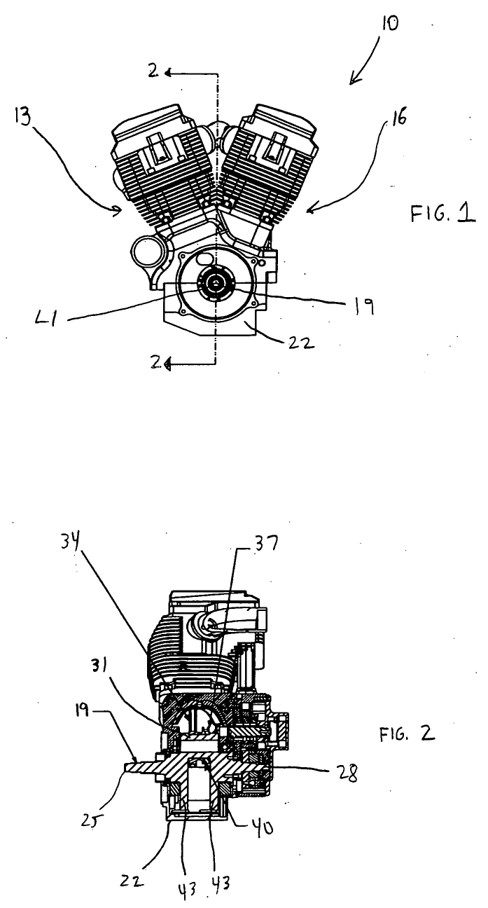

Turning to FIG. 2, the crankshaft 19 is rotatably mounted in the crankcase 22 and has longitudinal opposite end portions 25, 28 journaled on the crankcase 22, respectively, via a pair of plain bearings (not designated). The end portion 25 of the crankshaft 19 projects outward from the crankcase 22 and forms a power take out portion of the engine 10. The end portion 28 projects rearward of the crankcase 22 for a purpose described below.

The crankshaft 19 has a longitudinal central portion forming a single offset journal or crankpin 31 to which two connecting rods 34 and 37 are attached side-by-side as indicated by arrow 40. The crankshaft 19 is also provided with counterweights 43.

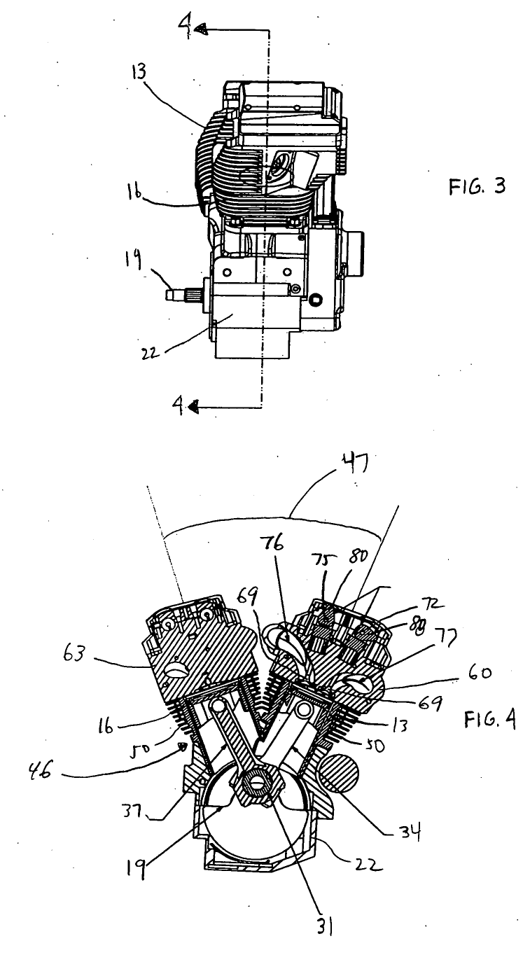

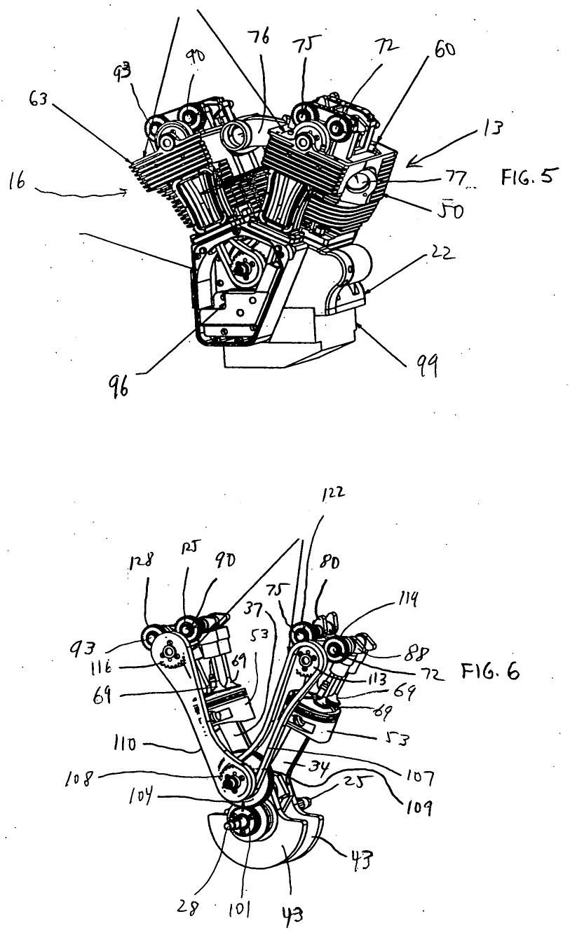

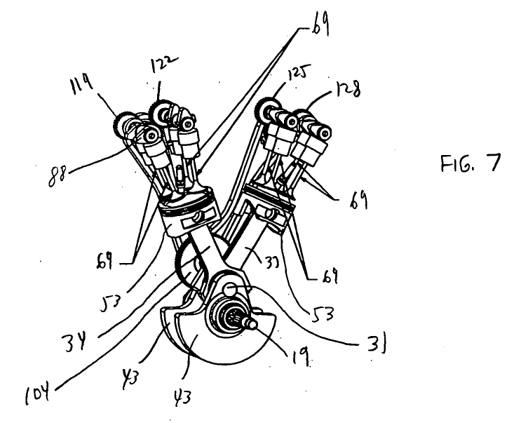

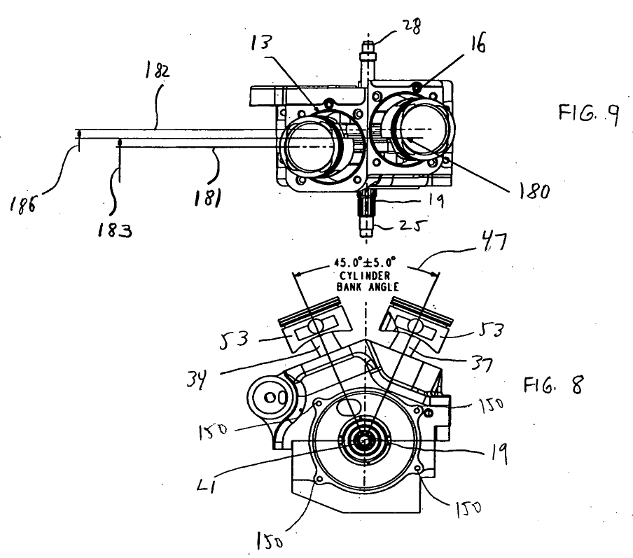

Turning to FIGS. 3-4, the cylinder blocks 13, 16 are attached to the crankcase 22 so that they are arranged at an angle to each other about the axis Ll (normal to the page in FIG. 1) of the crankshaft 119. The cylinder blocks 13, 16 have a mounting end 46 fitted in the crankcase 22. The angle between the cylinder blocks 13, 16, that is, the bank angle 47 is forty to fifty degrees and is shown at approximately 45 degrees in FIG. 4, although other bank angles are also suitable as will be evident to those of ordinary skill in the art. Also as will be evident to those of ordinary skill in the art, the cylinder blocks 13, 16 may be attached to the crankcase 22 by means of screws, stud bolts and nuts, or the like.

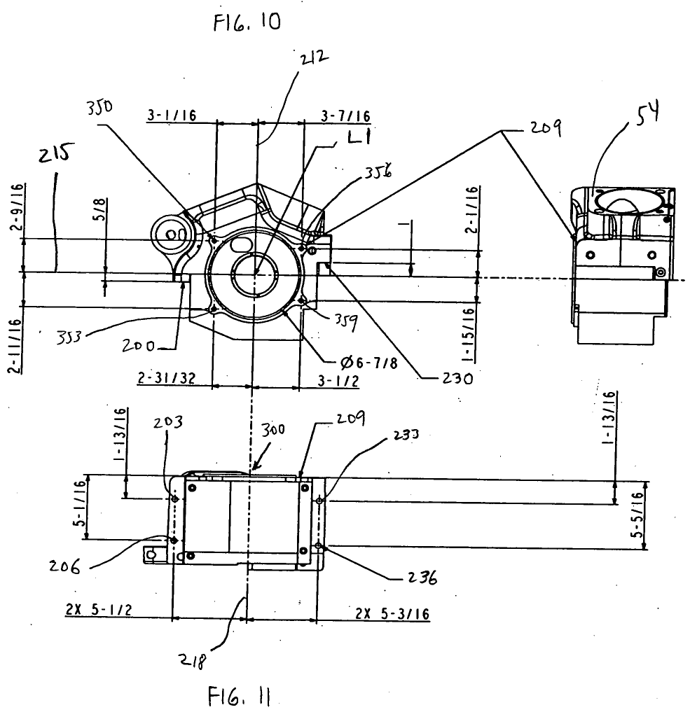

The cylinder blocks 13, 16 are each provided with a multiplicity of cooling fins 50. A mating surface 54 (FIG. 10) of each cylinder block 13, 16 relative to the crankcase 22 is preferably set to be positioned near the endmost cooling fin 50. As described in greater detail in connection with FIG. 9, the cylinder blocks 13, 16 are offset from each other in the axial direction of the crankshaft 19 (L1) so that the connecting rods 34, 37 can be disposed side by side on the single crankpin 31.

The tops of the cylinder blocks 13, 16 are covered by cylinder heads 60 and 63. On the right hand side of FIG. 4, the front cylinder head 60 is shown with a bank of cam operated valves 69 disposed thereon. Dual overhead cam shafts 72 and 75 operate four valves 69 for each cylinder. On the left hand side of cylinder head 60, an intake port 76 is shown. The cam operated valve 69 shown on the left side opens on intake by means of cam 80 connected to cam shaft 75 to allow the fuel-air mixture to enter the combustion chamber. On the right hand side of the cylinder head 60, an exhaust port 77 is shown. A cam operated valve 69 operated by cam 88 connected to cam shaft 72 opens and closes in order to allow the exhaust gases to exit from the cylinder at the end of the cycle. There are two intake valves and two exhaust valves for each cylinder. In FIG. 4, the second row of intake and exhaust valves are in alignment behind the valves shown and therefore are not visible. In FIGS. 6 and 7 which are discussed in greater detail below, all four of the valves are shown.

In FIG. 5, the cylinder head covers are removed for clarity. Cylinder head 60 has two overhead camshafts 72 and 75. Cylinder head 63 has two overhead camshafts 90 and 93. Cylinder blocks 13 and 16 are mounted to the crankcase 22 at mounting ends 46. The engine 10 is air cooled by means of fins 50. An oil pump assembly 96 and oil pan 99 are installed in the crankcase 22 as known to those of ordinary skill in the art and therefore will not be described in detail herein. The lubrication system may comprise a high pressure feed, dry sump oiling system.

Turning to FIGS. 6-7, the engine linkage is shown with the cylinder blocks, heads and covers removed for clarity. As shown a gear wheel 101 engaged with end portion 28 of the crankshaft 19 engages with a gear wheel 104. Timing chains 107 and 110 are connected to drive sprockets 108, 109 by the gearshaft of gear wheel 104. Driven sprockets 113 and 116 rotate gear wheels (not shown) that engage with gear wheels 119, 12, 125, and 128 attached to camshafts 72, 75, 90, and 93. Rotation of the cam shafts causes the cams to rotate to open valves 69 at the intake and exhaust ports of the combustion chamber. The valves 69 include shim and bucket type lifters. And the camshafts may be provided with manual adjust cam chains.

In FIG. 8, the cylinder bank angle 47 is shown. Also, the mounting holes 150 for mounting the transmission to the crankshaft 19 and crankcase 22 are shown.

Turning to FIG. 9, the cylinder blocks 13 and 16 are preferably offset from a centerline 180 corresponding to the OEM cylinder centerline location. The cylinder block 13 has a centerline 181 that is offset from centerline 180 by a distance 183. In the example, the distance 183 is 0.6 in. The cylinder block 16 has a centerline 182 that is offset from centerline 180 by a distance 186. In the example, the distance is 0.6 in.

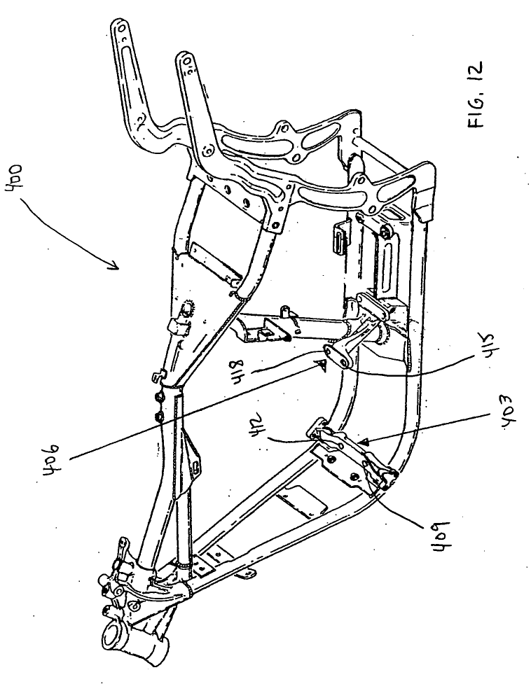

Referring to FIGS. 10-11, the mounting arrangement for mounting the primary drive to the crankcase 22 and crankshaft 19 and for mounting the engine 10 to the frame is shown. The mounting locations are shown in relation to a reference point 300 located at the center of the crankshaft in the x and y directions and located at the primary drive mounting surface 209 in the z-direction.

The axes are labeled 212, 215, and 218, respectively. The z-axis 218 is normal to the page in the orientation shown in FIG. 10. The front engine pad 200 has a pair of mounting holes 203 and 206. As measured in inches from the reference point 300 (0, 0, 0) hole 203 is located at (−5½, −⅝, −1 13/16) and hole 206 is located at (−5½, −⅝, −5 1/16).

The rear engine pad 230 has a pair of mounting holes 233 and 236. Hole 233 is located at (5 3/16, 1, −1 13/16) and hole 236 is located at (5 3/16, 1, −5 1/16).

The drive mounting surface 209 is provided with a plurality of mounting holes 350, 353, 356, and 359. As measured in inches from the reference point, hole 350 is located at (−3 1/16, 2 9/16, 0). Hole 353 is located at (−2 31/32, −2 11/16, 0). Hole 356 is located at (3 7/16, 2 1/16, 0). Hole 359 is located at (3½, −1 15/16, 0).

In FIG. 12, a motorcycle frame 400 is shown. The frame 400 has an engine mount 403 for receiving the front engine pad 200 and has an engine mount 406 for receiving the rear engine pad 230. The holes 203 and 206 align with openings 409 and 412 on the frame 400.

Holes 233 and 236 align with openings 415 and 418 in the engine mount 406. As will be evident to those of ordinary skill in the art, the front and rear engine pads 200 and 230 may be used to attach the crankcase 22 to the motorcycle frame 400 by suitable fasteners.

The frame 400 is an example of a frame that is suitable for use with the present invention. As will be evident to those of ordinary skill in the art, the engine 10 of the present invention can be used with any OEM or aftermarket frame having the EVO crankcase mounts and having sufficient clearance within the frame rails.

Obviously, various minor changes and modifications of the present invention are possible in the light of the above teaching. It is therefore to be understood that within the scope of the appended claims, the present invention may be practiced otherwise than as specifically described.

1. A V-2 engine comprising:
a crankcase;
a crankshaft rotatably supported in the crankcase, the crankshaft defining a longitudinal axis;
one crankpin disposed on the crankshaft at a position spaced apart from the longitudinal axis;
two cylinder blocks each having a cylinder head, the cylinder blocks mounted to the crankcase such that the cylinder blocks are arranged at an angle to each other, the cylinder blocks being offset from each other along the longitudinal axis such that a first connecting rod in the first cylinder block and a second connecting rod in the second cylinder block are capable of being connected in side-by-side fashion to the one crankpin, the engine being air-cooled by fins located on the cylinder head and cylinder blocks;
four valve mechanisms mounted to each cylinder head;
two camshafts mounted to the cylinder head of each cylinder block;
a power transmitting mechanism for transmitting rotational power from the crankshaft to the camshafts to drive the valve mechanisms; and,
wherein the crankcase fits onto stock front and rear EVO crankcase mounts and the crankcase mates with stock EVO primary drive and crankshaft mounts.

2. The engine of claim 1, wherein the cylinder blocks have a plurality of fins disposed thereon.

3. The engine of claim 1, wherein two of the valve mechanisms are intake valves.

4. The engine of claim 1, wherein two of the valve mechanisms are exhaust valves.

5. The engine of claim 1, wherein the cylinder blocks have a bank angle of approximately forty to fifty degrees.

6. A V-2 engine, comprising:
an air-cooled crankcase;
a crankshaft rotatably supported in the crankcase, the crankshaft defining a longitudinal axis;
two crankshaft journals disposed on the crankshaft at a position spaced apart from the longitudinal axis;
two cylinder blocks each having a cylinder head, the cylinder blocks mounted to the crankcase such that the cylinder blocks are arranged at an angle to each other, the cylinder blocks being offset from each other along the longitudinal axis such that a first connecting rod in the first cylinder block and a second connecting rod in the second cylinder block are capable of being connected in side-by-side fashion to the two crankshaft journals;
four valve mechanisms mounted to each cylinder head, the four valve mechanisms including two intake valves and two exhaust valves;
two camshafts mounted to the cylinder head of each cylinder block;
a power transmitting mechanism for transmitting rotational power from the crankshaft to the camshafts to drive the valve mechanisms; and,
wherein the crankcase fits onto stock front and rear EVO crankcase mounts and the crankcase mates with stock EVO primary drive and crankshaft mounts.

7. The engine of claim 6, wherein the cylinder blocks have a bank angle of approximately forty to fifty degrees.
